(19) United States
(12) Patent Application Publication
(10) Pub. No.: US 2004/0108207 A1
(43) Pub. Date: Jun. 10, 2004

(54) Injection and separation system and method employing transient isotachophoretic stacking

(75) Inventors: Ronald T. Kurnik, Foster City, CA (US); Stephen J. Williams, San Mateo, CA (US)

Correspondence Address: PERKINS COIE LLP, P.O. BOX 2168, MENLO PARK, CA, 94026, US

(73) Assignee: Aclara BioSciences, Inc.

(21) Appl. No.: 10/034,278

(22) Filed: Dec. 28, 2001

Related U.S. Application Data
(63) Continuation-in-part of application No. 09/780,638, filed on Feb. 10, 2001.
Application No. 09/780,638 is a continuation-in-part of application No. 09/933,993, filed on Aug. 20, 2001, now Pat. No. 6,685,813.
(60) Provisional application No. 60/182,049, filed on Feb. 11, 2000.
(60) Provisional application No. 60/185,035, filed on Feb. 25, 2000.

(51) Int. Cl. G01N 27/26

(52) U.S. Cl. 204/450; 204/451

(57) ABSTRACT

Methods of sample loading and separation in a microfluidics device are described. The methods provide high resolution and high signal intensity, using, in a preferred embodiment, a simple two-electrode injection scheme with transient isotachophoretic (ITP) stacking.

This application claims priority to copending U.S. applications having Ser. Nos. 09/780,638, filed Feb. 10, 2001, and 09/933,993, filed Aug. 20, 2001, both of which in turn claim the benefit of U.S. Provisional Applications having Serial Nos. 60/182,049, filed Feb. 11, 2000, and 60/185,035, filed Feb. 25, 2000. All of these applications are hereby incorporated by reference in their entirety and for all purposes.

### FIELD OF THE INVENTION

The field of this invention is related to sample loading, stacking, and separation in a microfluidics device.

### References

F. Foret et al., Electrophoresis 14:417-428 (1993).

Jacobsen, S.C. et al., Anal. Chem. 66:1107-1113 (1994).

Olechno, J. D. and Nolan, J. A., “Injection Methods in Capillary Electrophoresis”, in CAPILLARY ELECTROPHORESIS IN ANALYTICAL BIOTECHNOLOGY, Righetti, P. G., ed., CRC Press, 1996.

Quirino, J. P. and Terabe, S., J. Chromatog. A 902:119-135 (2000).

### BACKGROUND OF THE INVENTION

Microfluidic technology is revolutionizing a substantial segment of the field of chemical and physical processing of various fluids. One area of microfluidics concerns the manipulation of small volumes of liquids on a solid substrate having a network of channels and reservoirs, typically in communication with voltage sources. By applying electric fields to electrically conducting liquids, volumes of fluid and/or ions can be moved from one site to another, different solutions can be formed by mixing liquids and/or ions, and various reactions, separations, and analyses can be carried out. In fact, in common parlance, such a system has been referred to as “a laboratory on a chip.” Various prior art devices of this type include those described in U.S. Pat. Nos. 6,010,608, 6,010,607, 6,001,229, 5,858,195, and 5,858,187, which stem from a family of applications concerned with injection of sample solutions. Other pertinent disclosures include U.S. Pat. No. 5,599,432, EP Pubn. No. 0620432 A, and Verheggen et al., J. Chromatog. 452 :615-622 (1988).

Many of the operations performed on such devices involve the electrophoretic separation of multiple sample components contained in dilute samples, e.g., samples with concentrations of sample components in the femtomolar to nanomolar range. Efficient electrophoretic injection of dilute samples frequently results in large sample volumes and poor resolution of the sample components. Various sample injection and separation procedures, typically employing branched channels and the use of multiple electrodes, have been developed to address this problem. Transient isotachophoretic (ITP) stacking of sample components, as described, for example, in Olechno et al. and Quirino et al., is effective to greatly increase sample concentration prior to separation. Application of varying voltages in “pinching” and “pullback” schemes, as described in co-owned U.S. application Ser. Nos. 60/185,035, 09/780,638, and corresponding PCT Pubn. No. WO 01/59440, has been used to improve sample geometry and resolution. However, the latter procedures can result in a reduction in the amount of sample which actually undergoes separation, giving low intensity upon detection, which is especially problematic for low quantities of sample.

It would thus be desirable to provide an electrophoretic system for improved separation and resolution of sample components present in low concentrations, with minimal sample loss.

### SUMMARY OF THE INVENTION

In one aspect, the invention provides a method for injecting a sample comprising a plurality of charged components and separating the components by electrophoresis in a microfluidics device. The microfluidics device includes a separation channel, having an upstream portion terminating in an upstream reservoir and a downstream portion terminating in a downstream reservoir, sample and drain channels intersecting the separation channel between the two channel portions at first and second junctions, respectively, and terminating in sample and drain reservoirs, respectively. The device further includes electrodes in contact with the fluid in each said reservoir, including an upstream electrode, a downstream electrode, a sample electrode, and a drain electrode.

The sample and drain channels of the device may intersect the separation channel at directly opposed junctions, to create a cross network, or they may intersect the separation channel at staggered junctions, to create a double-T network. In the latter case, the sample channel can be either upstream or downstream of the drain channel.

In accordance with the injection and separation method:

a) a first electrolyte solution is placed into the separation channel, side channels and drain reservoir; and

b) the sample and a second electrolyte solution are placed into the sample

reservoir;

wherein the first and second electrolyte solutions each comprise an ion having lower mobility in an electric field than any of the charged components, and one or the other of the electrolyte solutions comprises an ion having higher mobility in an electric field than any of the charged components;

c) a first voltage gradient is created between the sample electrode and the drain electrode, such that the charged components move into the separation channel and become stacked within a region of the separation channel; and

d) at least one of the sample and drain electrodes is placed in a floating state, and a second voltage gradient is created between the downstream and upstream electrodes, such that the charged components move through the separation channel and separate into discrete bands according to their electrophoretic mobilities.

The concentration of the low mobility ion in the first and second electrolyte solutions is typically in the range of about 1 to 500 mM., and preferably in the range of about 1 to 50 mM. The concentration of the charged components in the sample is typically in the range of about 0 pM to 100 μM; in one embodiment, the concentration of the charged components in the sample is in the range of about 0.1 pM to 1 μM. The concentration of the high mobility ion is typically in the range of about 1-100 mM, and preferably in the range of about 20-35 mM. In one embodiment, termed “front stacking”, only the first electrolyte solution comprises the high mobility ion, and in another embodiment, termed “back stacking”, only the second electrolyte solution comprises the high mobility ion.

When the charged components are negatively charged, the higher mobility ion is preferably selected from the group consisting of chloride, bromide, fluoride, and nitrate. In one embodiment, the higher mobility ion is chloride. The low mobility ion, for negatively charged sample components, is preferably selected from the group consisting of HEPES (2-[4-(2-hydroxyethyl)-1-piperazinyl] ethanesulfonic acid), TAPS (3-[tris(hydroxymethyl) methylamino]-1-propanesulfonic acid), MOPS (3-(4-morpholinyl)-1-propanesulfonic acid), CHES (2-(cyclohexylamino) ethanesulfonic acid), MES (2-(4-morpholinyl) ethanesulfonic acid), and imidazole.

In one embodiment, both the sample and drain electrodes are in a floating state during step (d); in another embodiment (termed “half pullback”), one of the sample and drain electrodes is in a floating state during step (d), and a voltage is applied between the other of these electrodes and the upstream electrode, where the voltage is in the same direction but of lower potential than that applied between the downstream and upstream electrodes.

In one embodiment, both the upstream and downstream electrodes are in a floating state during step (c). In another embodiment (termed “pinching”), during step (c), a voltage gradient is created between the upstream and drain reservoirs, and between the downstream and drain reservoirs, in the same direction as that created between the sample and drain reservoirs. In one instance, a voltage is applied to the drain electrode, and the sample, upstream and downstream electrodes are grounded.

The charged sample components may be selected from the group consisting of nucleic acids, proteins, polypeptides, polysaccharides, and synthetic polymers; in one embodiment, the charged sample components comprise nucleic acids. In another embodiment, the charged components comprise labeled molecules, termed “eTags”, having distinct and characterized electrophoretic mobilities, said molecules having been cleaved from molecular species with biological or chemical recognition properties in the course of a multiplexed chemical or biochemical assay.

These and other objects of the invention will become more fully apparent when the following detailed description of the invention is read in conjunction with the accompanying drawings.

### BRIEF DESCRIPTION OF THE FIGURES

FIG. 1 illustrates a microfluidics system constructed in accordance with the present invention, for carrying out the separation method of the invention;

FIGS. 2A-2C are a schematic illustration of transient isotachophoretic (ITP) stacking followed by electrophoretic separation, in accordance with an embodiment of the invention (dimensions and regions not necessarily shown to scale);

FIGS. 3A-3C are a schematic illustration of transient isotachophoretic (ITP) stacking followed by electrophoretic separation, in accordance with a further embodiment of the invention (dimensions and regions not necessarily shown to scale);

FIG. 4 illustrates resolution and signal intensity obtained in electrophoretic analysis using a stacking/floating injection and separation process, in accordance with an embodiment of the present invention, as compared with a “pinch/pullback” process;

FIGS. 5A-C give further comparisons of electrophoretic analysis using different injection and separation methods (floating vs. pinch/pullback) with and without initial ITP sample stacking;

FIG. 6A shows a comparison of analyses using different combinations of injection and separation methods; i.e. (1; top scan) pinch injection/pullback separation; (2) pinch injection/floating separation; (3) floating injection/pullback separation; and (4; bottom scan) floating injection/floating separation, with back stacking (33 nM NaCl added to sample); and

FIG. 6B graphically compares signal intensities of sample peaks in FIG. 6A.

### DETAILED DESCRIPTION OF THE INVENTION

I. Microfluidic System

The invention includes, in one aspect, a microfluidic system for use in electrophoretic separation of components having a given negative or positive charge and contained in a dilute sample. By “sample ” is meant an aqueous sample containing one or more charged components which can be separated electrophoretically, and preferably detected by standard optical techniques applicable to capillary zone electrophoresis. By “dilute sample” is meant a sample in which at least one of the components to be separated and detected is present at a concentration as low as 100 fM (femtomolar), typically 1 pM (picomolar) to higher concentrations, e.g., several hundred nanomolar of higher, preferably in the 1-500 pM range. However, more concentrated samples, e.g. up to about 100 μM, may also be used.

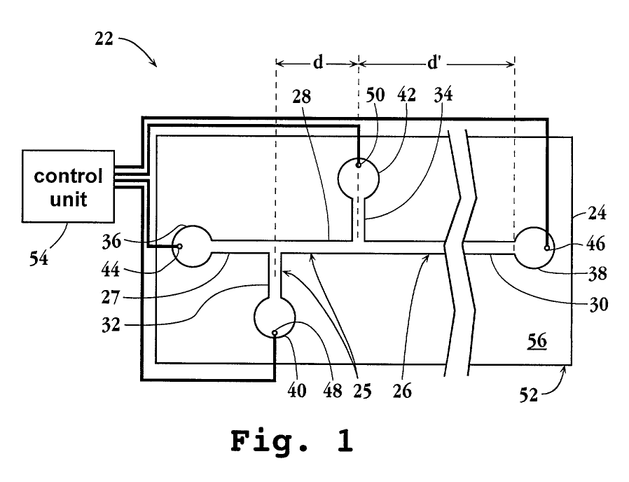

One exemplary system in accordance with the invention is shown at 22 in FIG. 1. The system includes a microfluidics device 24 having formed therein one or more channel networks, such as network 25 composed of a separation microchannel 26 having, in an upstream to downstream direction, an upstream channel region 27, a sample-volume channel region 28, and a downstream separation channel region 30. The sample-loading region is defined, at its upstream end, by a first side channel 32 and a second side channel 34, which intersect the separation channel at first and second junctions. The length of the sample-loading region d is measured as the distance between a first-channel region adjacent the upstream side of the first channel, and a second-channel region adjacent the downstream side of the second channel, as shown. The downstream separation region has a length d′, as indicated. In preferred embodiments of the invention, the ratio of the lengths of the sample-volume region to the downstream separation region in the device, d:d′ is between about 1:500 to 1:1.

As will be discussed below, the system may include a plurality of devices of the types illustrated, each with a different selected d:d′ ratio, e.g., devices having selected ratios of 1:500, 1:50, 1:20, 1:10, 1:5, 1:2, and 1:1, where the particular device selected has an optimal ratio for the component separation desired. Although only a single channel network is shown in the Figures, the device may include an array of channel networks, each having the general features described for network 26. In this embodiment, the device may include micropatterned conductors connecting each of the corresponding reservoirs in the networks to a common lead for connection to the control unit.

The separation channel terminates and is in fluid communication at its upstream and downstream ends with upstream and downstream reservoirs 36, 38, respectively. Similarly, the first and second side channels terminate and are in fluid communication with first and second reservoirs 40, 42. Each reservoir contains or is adapted to receive an electrode, which may be formed on the substrate or formed independently, e.g. on an electrode plate for placement on the substrate for electrode contact with liquid in the associated reservoirs. The electrodes associated with reservoirs 36, 38, 40, 42 are indicated at 44, 46, 48, 50, respectively. Each electrode is operatively connected to a control unit or voltage controller 54, which operates in various modes described below.

As will be seen below, the electrodes in first and second reservoirs 40, 42, respectively, are used for moving fluid material in and out of the reservoirs electrophoretically. Alternatively, fluid movement in and out of the electrodes may be effected by a pressure or vacuum source operatively connected to the first and second reservoirs, and under the control of the control unit.

With respect to the fabrication of the microfluidics device in the system, the channel network may be conventionally formed on a substrate or card 52, and covered by a transparent cover or film 56, which is attached or bonded to the card in a conventional manner. The substrate in which the channels are present generally has a thickness of at least about 20 82 m, more usually at least about 40 μm, and not more than about 0.5 cm, usually not more than about 0.25 cm. The width of the substrate is determined by the number of units to be accommodated and may be as small as about 2 mm or up to about 6 cm or more. The dimension in the other direction is generally at least about 0.5 cm and not more than about 50 cm, usually not more than about 20 cm.

The substrate may be a flexible film or relatively inflexible solid, where the microstructures, such as reservoirs and channels, may be provided by embossing, molding, machining, etc. The channel dimensions are generally in the range of about 0.1 μm to 1 mm deep and about 0.5 μm to 1 mm wide, where the cross-section is generally 0.1 μm² to about 1 mm² . The channel lengths may vary widely depending on the operation for which the channel is to be used, generally being in the range of about 0.05 mm to 50 cm, more usually in the range of about 0.5 mm to 20 cm. The main (separation) and side channels may have the same or different cross-sectional areas, as well as the same or different shapes. As noted above, the ratio of the lengths of the sample-loading region and the separation region is typically a selected ratio between about 1:500 and 1:1.

The reservoirs generally have volumes in the range of about 10 nl to 100 μl; more usually in the range of about 500 nl to 10 μl. The reservoirs may be cylindrically shaped, conically shaped, e.g. the frustum, or other regular shape.

The fabrication of the device may include fabrication of the substrate comprising the microfeatures, a supporting film, an enclosing film, or combinations thereof. A supporting film will generally be at least about 40 μm and not more than about 5 mm thick. The film used to enclose the channels and the bottom of the reservoirs generally has a thickness in the range of about 10 μm to 2 mm, more usually in the range of about 20 μm to 1 mm. The selected thickness may be controlled by the desire for good heat transfer, e.g. temperature control, but otherwise is usually selected for convenience and assurance of good sealing and the manner in which the devices will be used to accommodate instrumentation. The enclosing film, where the bottom of the substrate is totally closed, will also have a thickness coming within the above range, and will include perforations in register with the reservoirs or other feature requiring access, while enclosing the channels. Therefore, the ranges are not critical.

As indicated, the substrate may be a flexible film or inflexible solid, so the method of fabrication will vary with the nature of the substrate. For embossing, at least two films will be used, where the films may be drawn from rolls, one film embossed and the other film adhered to the embossed film to provide a physical support. The individual units may be scored, so as to be capable of being used separately, or the roll of devices retained intact. See, for example, co-owned PCT Pubn. No. WO 9919717. Where the devices are fabricated individually, they are usually molded, using conventional molding techniques. The substrates and accompanying film are generally plastic, particularly organic polymers, where the polymers include addition polymers, such as acrylates, methacrylates, polyolefins, polystyrene, etc., or condensation polymers, such as polyethers, polyesters, polyamides, polyimides, dialkyl siloxanes, or norborane (“ZEONOR”-type) polymers, although glasses, silicon or other material may be employed. Desirably, the polymers have low fluorescence inherently or can be made so by additives or bleaching, e.g. photobleaching. A film is usually be placed over the substrate to enclose at least the channels, which film usually has openings for communicating with the reservoirs and, where appropriate, introducing electrodes into the reservoirs. The enclosing film is adhered to a substrate by any convenient means, such as thermal bonding, adhesives, etc. The literature has many examples of adhering such films; see, for example, U.S. Pat. Nos. 4,558,333 and 5,500,071.

The control unit includes a power source or voltage sources which is operatively connected to the electrodes in the device, as shown. The power source is under the control of an electronic controller in the control device. The controller determines the sequence and timing of voltages applied to the electrodes, and the voltage levels, in carrying out the method of the invention. The operation and design of the controller will be appreciated from the operation of the device described below.

In one embodiment, the invention provides a plurality of different devices with different channel-volumes, e.g., different length channel-volume regions, which can be selected to provide a minimum sufficient volume for the particular sample to be analyzed. For example, the ratio of lengths of the sample-volume region to the length of the separation channel can vary from a minimum of about 1:500 to a maximum of about 1:1. As the ratio of the two lengths increases, more sample can be applied, allowing detection of lower concentration components.

II. Sample-Component Separation Method

A. Injection and Separation Procedures

The separation method involves an initial sample-stacking step carried out under isotachophoretic (ITP) conditions. The electrolyte components of the background and sample solutions are selected, particularly in relation to the length of the sample volume region, i.e., total sample volume, to permit the sample to initially stack into a small volume by ITP.

The theory of isotachophoretic separation is described, e.g., in Olechno et al., cited above, at pp. 84-87. Isotachophoretic stacking, as applied to sample concentration prior to capillary electrophoresis, is described, for example, in the above reference at pages 87-89, and in the citedreview article by Quirino and Terabe.

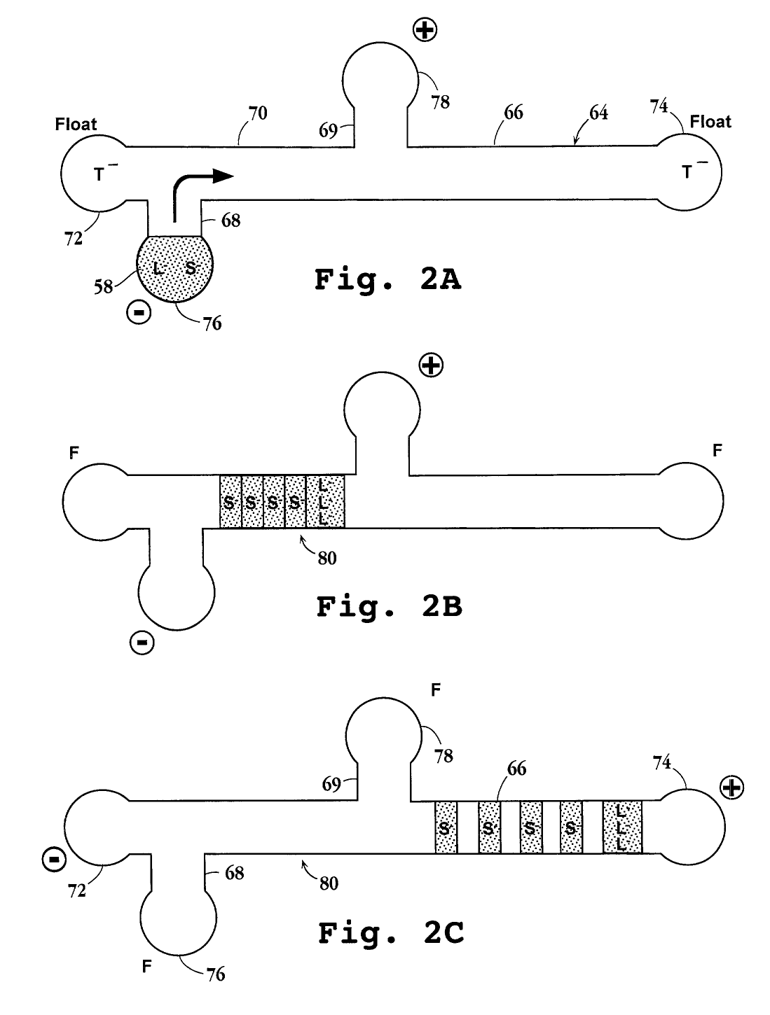

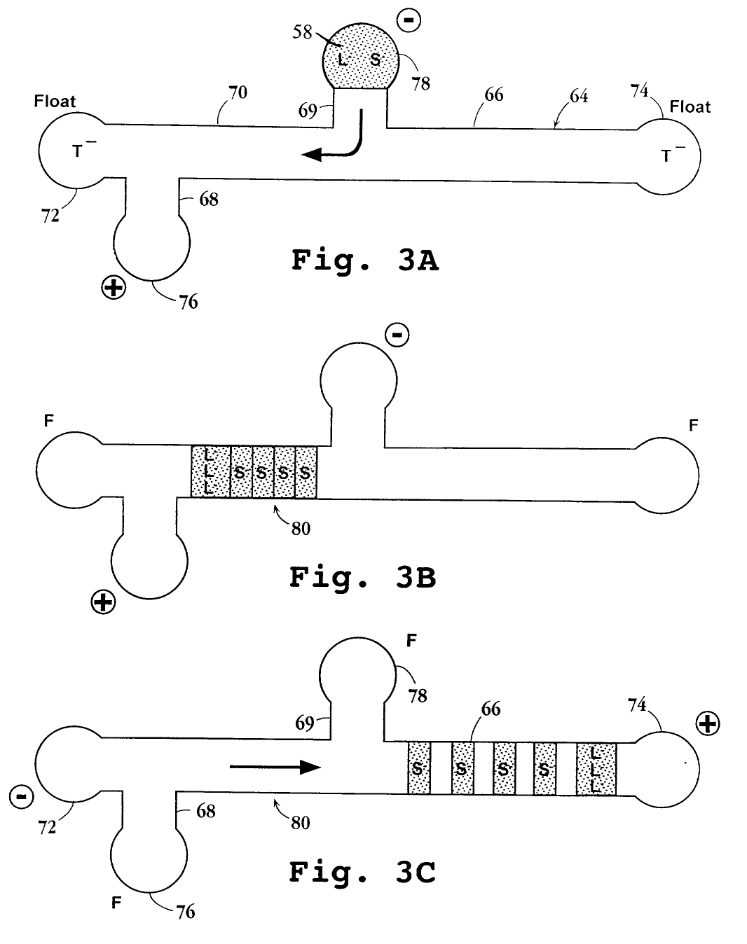

The processes described herein refer to a microfluidic device such as that shown in FIGS. 1-3. With reference to FIGS. 2-3, the device includes a separation channel 64, with an upstream portion 70 terminating in an upstream reservoir 72 and a downstream portion 66 terminating in a downstream reservoir 74, sample and drain channels 68 and 69 (or vice versa) intersecting the separation channel at first and second junctions, respectively, and terminating in sample and drain reservoirs 78 and 76 (or vice versa), respectively. As described below, either side channel can be used as the sample channel, and the other as the drain channel.

In the figures, the sample components to be separated are negatively charged, as are the electrolyte ions, and the polarity of voltage is applied with the polarity shown, to attract the negatively charged components toward the right in the figures. The processes described herein can clearly be applied to positively charged components by altering the voltages and electrolytes accordingly.

With reference to FIG. 2A, a sample 58, containing, in this case, negatively charged sample components (S−) with different electrophoretic mobilities, is provided in a buffer solution. In one embodiment, termed “back stacking”, the sample solution also includes an ion (L− in the Figures) having greater electrophoretic mobility than any of the sample components, e.g. a small ion such as chloride ion, typically present in a significantly higher concentration than the sample ions (i.e. from about 1 to 100 mM).

The separation channel and side channels of the device are filled with a solution of an ion (T− in the Figures) having lower electrophoretic mobility than any of the sample components, which is frequently the same buffer ion as used for the sample buffer solution. (While this background electrolyte solution may also contain some high mobility ion in this embodiment, it is present in much lower concentration than in the sample solution, and is preferably absent.)

The sample, containing the high mobility ion, is placed in the sample reservoir as shown, and a voltage gradient is created between the sample reservoir and the drain reservoir, as indicated. As shown in FIGS. 2A and 3A, a positive voltage, with respect to ground, is applied to the drain reservoir (78 in FIG. 2A and 76 in FIG. 3B). Typically, the voltage applied is a DC voltage of between 10-5000 volts. The bolus of sample and high mobility ion move into the sample channel and thence into the separation channel. Because the electric field across each section is inversely proportional to the conductivity in that section, sections associated with high mobility ions are characterized by relatively low electric fields, and sections associated with lower mobility ions, with relatively high electric fields. This electric field or voltage gradient maintains the sample components in a narrow band, in order of their mobility. Each sample component migrates to a position closely adjacent the sample components nearest in electrophoretic mobility, causing the components to stack into a tight sample band of separated components between the high-and low-mobility electrolytes. Sample ions that diffuse back into the background (trailing) electrolyte “speed up” under the higher electric field, and those that diffuse forward into the mobility (leading) ion region slow down under the lower electric field. The stacking occurs within a sample volume region 80 of the electrophoresis channel, between the first and second junctions, as shown in FIG. 2B, and may also continue farther downstream in the separation channel.

In another embodiment (not illustrated), termed “front stacking”, the background electrolyte solution filling the electrophoresis channel contains a high concentration of the high mobility ion (e.g. chloride ion) in addition to the buffer ion, and the sample is provided in the low mobility ion solution (e.g. buffer) containing a low or preferably zero concentration of the high mobility ion. In either front or back stacking, the sample bands are arrayed so that faster-migrating components are positioned downstream of slower-moving components.

In a further embodiment, shown in FIGS. 3A-3B, the positions of the sample and drain reservoirs are reversed, such that high mobility ion and sample 58 are placed in reservoir 78, and a positive voltage is applied to reservoir 76. Sample ions stack according to electrophoretic mobility, as described above, but in the reverse orientation with respect to the “downstream” and “upstream” ends of the separation channel. Either front or back stacking, as described above, may be employed; that is, either the background or sample solution may contain high mobility ion.

During the injection process, as shown in FIGS. 2A-B and 3A-B, electrodes in contact with reservoirs 72 (upstream) and 74 (downstream) are preferably in a floating state. As used herein, “floating” indicates that the electrode is not in electrical communication with any of the other electrodes in communication with the fluid in the device via any electrical wiring or solid-state circuitry, although it is in electrical communication via the conductive electrolyte solutions in the various interconnected channels.

Optionally, during the injection procedure, a voltage gradient may be applied between reservoir 72 (upstream) and the drain reservoir (76 or 78), and between reservoir 74 (downstream) and the drain reservoir (76 or 78), in the same direction as that created between the sample an drain reservoirs. For example, in the embodiment of FIG. 2A, a positive voltage would be applied to reservoir 78, and the electrodes in contact with reservoirs 76, 72, and 74 would be grounded. In the embodiment of FIG. 3A, a positive voltage would be applied to reservoir 76, and the electrodes in contact with reservoirs 78, 72, and 74 would be grounded. This results in a sample shaping phenomena known as “pinching”, preventing migration of the sample out of the sample-volume region, that is, towards the upstream or downstream reservoirs.

ITP stacking, as described above, provides efficient concentration of very dilute samples, typically by a factor of 100 or more, depending on the length of the sample-loading regions. The limitation of ITP as a separation technique, however, is relatively poor resolution of dilute sample components. Accordingly, a combination of transient ITP stacking and capillary zone electrophoresis (CZE), which is better able to spatially resolve dilute sample components of different electrophoretic mobility, is used. Conditions allow for initial small-volume stacking by ITP, followed by a transition to CZE once ITP stacking is achieved.

In operation, after the sample-loading step, a control unit (as shown in FIG. 1) operates to apply a voltage potential between reservoirs 72 (upstream) and 74 (downstream). In accordance with one embodiment of the present invention, at least one of, and preferably both of, the electrodes in contact with reservoirs 78 and 76 (sample and drain) are placed in a floating state during the separation step, as shown in FIGS. 2C and 3C. It should be noted that stacking of the components can continue after the voltage has been switched in this way to “separation” mode, and can physically extend beyond the region between the sample and drain channels (first and second junctions).

As can be seen from FIGS. 3B and 3C, in the embodiment shown, the voltage applied across the stacked sample bands reverses direction upon switching from “injection” mode (3A-B) to “separation” mode (3C).

With the continued application of voltage across the sample (i.e. between the downstream and upstream reservoir), the zone occupied by the high mobility ion (e.g. chloride) eventually broadens due to electromigration dispersion (see e.g. Foret et al. or Olechno et al.), its concentration decreases, and its electric field strength increases, leading eventually to a loss of the field strength gradient needed for ITP. As mixing of adjacent ion bands occurs, the sample components migrate and are separated under electrophoretic forces, as illustrated in FIGS. 2C and 3C.

The “separation mode” voltage schemes described above, i.e. with a voltage potential between the upstream and downstream reservoirs and at least one of the sample and drain reservoirs floating, provides certain advantages over a “pullback” scheme, in which a same direction but lesser voltage potential is applied to both reservoirs 78 and 76 (sample and drain). This “pullback” scheme serves to direct electrolyte moving downstream from reservoir 72 into the side channels 68 and/or 69, and to direct any sample present in the side channels away from the downstream separation channel. The purpose of such a scheme is to eliminate diffusion or migration of sample components into the separation channel upstream of the sample plug during sample injection and separation. However, it can also result in significant loss of sample into the side channels.

In a “half pullback” scheme, one of the sample and drain reservoirs is floating, and the other has a low positive voltage applied (i.e. the same direction as the upstream-downstream potential but lower potential). This scheme serves to reduce sample diffusion and migration from the side channels, as described above, but with less sample loss.

B. Sample and Electrolyte Components

The concentrations of the electrolyte solutions are generally be in the range of about 0.1 to 1,000 mM, more usually in the range of about 1 to 50 mM. The sample concentration may also vary widely, depending on the nature of the sample, the number of components, the ease with which they can be separated, etc. Generally, the total concentration of the components of the sample to be assayed will be in the range of about 0.1 pM to 1 μM, although higher concentrations, up to about 100 μM, can also be assayed. The concentration of high mobility ion added to the sample (for “back stacking”) or, alternatively, the background electrolyte (for “front stacking”), is preferably in the range of about 1 to 100 mM, more preferably about 20 to 35 mM, and is typically comparable to or greater than the buffer (background) ion concentration.

Illustrative electrolytes include, for example, HEPES (2-[4-(2-hydroxyethyl)-1-piperazinyl]ethanesulfonic acid), TAPS (3-[tris(hydroxymethyl) methylamino]-1-propanesulfonic acid), CAPS (3-(cyclohexylamino)-1-propanesulfonic acid), (tris(hydroxymethyl)aminomethane) chloride (Tris Cl), sodium glycinate, sodium citrate, sodium phosphate, sodium borate, sodium tetraborate, sodium taurodeoxycholate, sodium formate, sodium ethane sulfonate, sodium pentane sulfonate, sodium tartrate, etc. While Tris and sodium are the most common cationic counterions, they may be replaced with ammonium, lithium, potassium, magnesium, etc. Anionic counterions include, for example, chloride, bromide, nitrate, nitrite, sulfate, cyanide, etc.

The low mobility ion is typically a buffer ion. In general, bulky ions will have lower mobility than equally charged small ions. For separation of negatively charged biomolecules, such as nucleic acids and certain proteins, suitable low mobility ions include HEPES, TAPS, MOPS (3-(4-morpholinyl)-1-propanesulfonic acid), CHES (2-(cyclohexylamino) ethanesulfonic acid), MES (2-(4-morpholinyl) ethanesulfonic acid), and imidazole. Suitable high mobility ions include chloride, bromide, fluoride, and nitrate.

C. Results

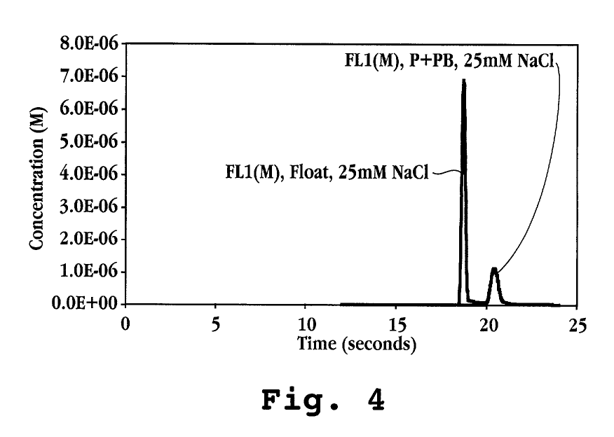

It was found that, in a preferred embodiment of the present method, where injection was carried out with electrodes at reservoirs 72 and 74 floating, and separation with reservoirs 78 and 76 floating, high resolution was obtained with minimal sample leakage. FIG. 4 shows results of injection and separation according to this preferred embodiment of the invention, using the voltage settings below, as compared to “pinch-pullback” injection and separation. In these procedures, the downstream side channel 78 was used as the sample channel and the upstream side channel 76 as the drain channel, as illustrated in FIG. 3A.

“Floating” Voltage Scheme:

| | Up (72) | Down (74) | Sample (78) | Drain (76) | Time (sec) |
|---|---|---|---|---|---|
| Injection | floating | floating | 0 | 500 | 12 |
| Separation | 0 | 700 | floating | floating | 25 |

“Pinch/Pullback” Voltage Scheme (Pinch Injection, Pullback Separation):

| | | | | | |
|---|---|---|---|---|---|
| Injection | 0 | 0 | 0 | 500 | 12 |
| Separation | 0 | 700 | 380 | 380 | 25 |

The dimensions of the device used for the experiment were as follows: upstream channel region 4 mm, sample volume channel region (“offset”, between side channel junctions) 250 μm, downstream separation channel region 11 mm, and side channels each 4 mm. The detector was situated at the 10 mm point of the 11 mm downstream separation channel. The background electrolyte was 25 mM HEPES, pH 7.38. The sample solution contained 1 μM fluorescein in 25 mM HEPES containing 25 mM NaCl (high mobility ion).

As shown in FIG. 4, the “floating” voltage scheme with transient ITP back stacking (i.e., using high NaCl concentration in the sample) gave a high resolution peak at the detector, as well as greatly enhanced sensitivity, compared to the “pinch/pullback” voltage scheme.

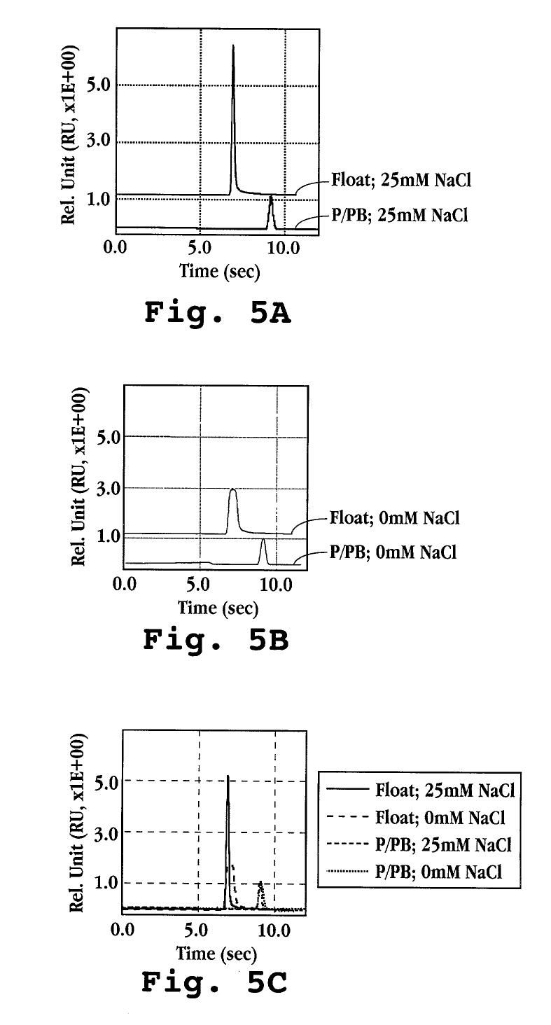

Further results are shown in FIGS. 5A-C, using the same solutions and voltages schemes, with a microfluidic device having a longer offset (sample volume region) of 400 μm. (In general, a longer offset, independent of other factors, is expected to give higher signal intensity, because more sample can be loaded into the longer channel region.) For injection with back stacking, the sample consisted of 1 μM fluorescein and 25 mM NaCl in 25 mM HEPES; for injection without stacking, the sample consisted of 1 μM fluorescein in 25 mM HEPES.

As shown in FIGS. 5A-C, the “floating” voltage scheme, with ITP stacking, gave consistently higher intensity and sharper peaks upon detection than the pinch/pullback voltage scheme, with or without ITP stacking. While stacking improved resolution somewhat for the pinch/pullback method, sample intensity was still low. Without initial ITP stacking, the “floating” scheme gave poorer resolution, as expected, though sensitivity was still high.

The following procedures were carried out on a device with a 3000 μm offset, using a sample containing four labeled “e-tags” (electrophoresis tags). Such tags have distinct and characterized electrophoretic mobilities, and are generated by target-specific cleavage of electrophoretic probes, typically molecular species with biological or chemical recognition properties, which are bound in assays to probe-specific targets. The e-tags are cleaved from such species in the course of multiplexed chemical or biochemical assays. Electrophoretic probes and tags of this type, and methods for their use in multiplexed assays, are described in co-owned PCT Pubn. Nos. WO 01/83502 and WO 00/66607, which are incorporated by reference herein.

The following voltage schemes were used, with reference to the schemes described above. In these separations, the downstream side channel 78 was used as the sample channel and the upstream side channel 76 as the drain channel, as illustrated in FIG. 3A.

1: Pinch injection/pullback separation

2: Pinch injection/floating separation

3: Floating injection/pullback separation

4: Floating injection/floating separation, with stacking (33 nM NaCl added to sample)

Absolute voltages, other than zero, may vary somewhat from those shown above. For example, for “floating injection/pullback separation” (scheme 3), during the “separation” phase, the voltages were 298 V at the sample electrode 78 and 172 V at the drain electrode 76, with the downstream electrode at a significantly higher voltage than either, and the upstream electrode at zero. The running buffer was 1% PEO (polyethylene oxide) in 25 mM HEPES.

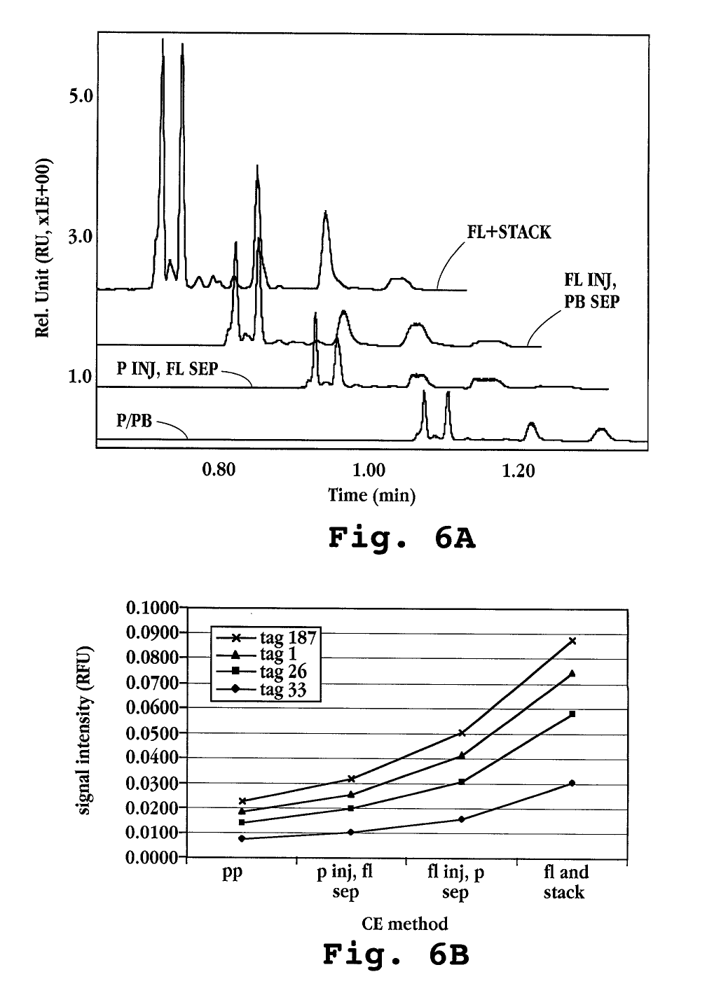

The results are shown in FIG. 6A and graphically in FIG. 6B. (Scans in FIG. 6A are offset for clarity; retention times were in fact fairly similar for each scan.) Again, the “floating” scheme (injection and separation) with transient ITP stacking (4; bottom scan in FIG. 6A) gave the highest intensity signals, and the pinch/pullback scheme (1; top scan) gave the lowest. Scheme 3 (second from bottom scan), with floating injection and pullback separation, gave somewhat higher intensity signals than scheme 2 (second from top scan), with pinch injection and floating separation.

The present method provides an improved sample separation method that gives high resolution, sharp peaks and high intensity signals. The invention now having been fully described, it will be apparent to one of ordinary skill in the art that many changes and modifications can be made thereto without departing from the spirit or scope of the appended claims.

It is claimed:

1. A method for injecting a sample comprising a plurality of charged components and separating the components by electrophoresis in a microfluidics device,
wherein said microfluidics device includes a separation channel, having an upstream portion terminating in an upstream reservoir and a downstream portion terminating in a downstream reservoir, sample and drain channels intersecting the separation channel between the two channel portions at first and second junctions, respectively, and terminating in sample and drain reservoirs, respectively; and said device further includes electrodes in contact with the fluid in each said reservoir, including an upstream electrode, a downstream electrode, a sample electrode, and a drain electrode;
the method comprising:
a) placing into said separation channel, side channels and drain reservoir a first electrolyte solution;
b) placing into said sample reservoir the sample and a second electrolyte solution;
wherein said first and second electrolyte solutions each comprise an ion having lower mobility in an electric field than any of said charged components, and one or the other of said electrolyte solutions comprises an ion having higher mobility in an electric field than any of said charged components;
c) creating a first voltage gradient between said sample electrode and said drain electrode, such that the charged components move into said separation channel and become stacked within a region of said separation channel; and
d) placing at least one of said sample and drain electrodes in a floating state, and creating a second voltage gradient between said downstream and upstream electrodes, such that the charged components move through the separation channel and separate into discrete bands according to their electrophoretic mobilities.

2. The method of claim 1, wherein, in step (d), said sample and drain electrodes are both in a floating state.

3. The method of claim 1, wherein, in step (d), one of said sample and drain electrodes is in a floating state, and a voltage is applied between the other of said electrodes and the upstream electrode which is in the same direction but of lower potential than that applied between the downstream and upstream electrodes.

4. The method of claim 1, wherein said sample and drain channels intersect said separation channel at directly opposed junctions, to create a cross network.

5. The method of claim 1, wherein said sample and drain channels intersect said separation channel at staggered junctions, to create a double-T network.

6. The method of claim 5, wherein the sample channel is upstream of the drain channel.

7. The method of claim 5, wherein the sample channel is downstream of the drain channel.

8. The method of claim 1, wherein said upstream and downstream electrodes are in a floating state during step (c).

9. The method of claim 1, wherein, during step (c), a voltage gradient is created between said upstream and drain reservoirs, and between said downstream and drain reservoirs, in the same direction than that created between said sample and drain reservoirs.

10. The method of claim 9, wherein, during step (c), a voltage is applied to said drain electrode, and said sample, upstream and downstream electrodes are grounded.

11. The method of claim 1, wherein the charged components are selected from the group consisting of nucleic acids, proteins, polypeptides, polysaccharides, and synthetic polymers.

12. The method of claim 11, wherein said charged components comprise nucleic acids.

13. The method of claim 1, wherein the charged components comprise labeled molecules having distinct and characterized electrophoretic mobilities, said molecules having been cleaved from molecular species with biological or chemical recognition properties in the course of a multiplexed chemical or biochemical assay.

14. The method of claim 1, wherein the charged components are negatively charged, and said higher mobility ion is selected from the group consisting of chloride, bromide, fluoride, and nitrate.

15. The method of claim 14, wherein the higher mobility ion is chloride.

16. The method of claim 1, wherein the charged components are negatively charged, and the low mobility ion is selected from the group consisting of HEPES (2-[4-(2-hydroxyethyl)-1-piperazinyl]ethanesulfonic acid), TAPS (3-[tris(hydroxymethyl) methylamino]-1-propanesulfonic acid), MOPS (3-(4-morpholinyl)-1-propanesulfonic acid), CHES (2-(cyclohexylamino) ethanesulfonic acid), MES (2-(4-morpholinyl) ethanesulfonic acid), and imidazole.

17. The method of claim 1, wherein the concentration of the low mobility ion in said solutions is in the range of about 1 to 500 mM.

18. The method of claim 17, wherein the concentration of the low mobility ion is in the range of about 1 to 50 mM.

19. The method of claim 1, wherein the concentration of the charged components in the sample is in the range of about 0.1 pM to 100 μM.

20. The method of claim 19, wherein the concentration of the charged components in the sample is in the range of about 0.1 pM to 1 μM.

21. The method of claim 1, wherein the concentration of the high mobility ion is in the range of about 1-100 mM.

22. The method of claim 21, wherein the concentration of the high mobility ion is in the range of about 20-35 mM.

23. The method of claim 1, wherein only the first electrolyte solution comprises said high mobility ion.

24. The method of claim 1, wherein only the second electrolyte solution comprises said high mobility ion.
